(19) United States
(12) Patent Application Publication
(10) Pub. No.: US 2013/0206533 A1
(43) Pub. Date: Aug. 15, 2013

(54) HYDRAULIC CONTROL SYSTEM FOR A DUAL CLUTCH TRANSMISSION

(71) Applicants: Shaun E. Mepham, Saline, MI (US); Eric Sharkness, Canton, MI (US)

(72) Inventors: Shaun E. Mepham, Saline, MI (US); Eric Sharkness, Canton, MI (US)

(73) Assignee: RICARDO, INC., Belleville, MI (US)

(21) Appl. No.: 13/576,949

(22) PCT Filed: Feb. 4, 2011
(86) PCT No.: PCT/US11/23737

§ 371 Date: Aug. 29, 2012

Related U.S. Application Data
(60) Provisional application No. 61/301,678, filed on Feb. 5, 2010.

(51) Int. Cl. F16D 48/02

(52) U.S. Cl. CPC F16D 25/14
USPC 192/48.601

(57) ABSTRACT

Control systems and methods for a dual clutch transmission are provided. The control system includes a first pump for providing a first fluid to actuate the dual clutch assembly, a second pump for providing a second fluid to cool the dual clutch assembly, and a motor operatively coupled to the first and second pumps. The motor is operable in first and second directions, wherein the first pump is responsive to operation of the motor in the first direction and the second pump is responsive to operation of the motor in the second direction. The first and second pumps can be coupled to the motor about a common transfer shaft. By selectively reversing motor rotation, the motor drives the first and second pumps to provide a flow rate of hydraulic fluid and to provide a flow rate of lubricating fluid, respectively.

### BACKGROUND OF THE INVENTION

The present invention relates to control systems for vehicle transmissions. More particularly, the present invention relates to hydraulic control systems for dual clutch transmissions.

Previously, the dual clutch transmission was offered as an improvement over existing manual or automatic transmissions by combining aspects of both designs. The dual clutch transmission generally includes two concentric or parallel input shafts each being connected between an engine and a final drive shaft. A dual clutch assembly including two multi-plate clutch assemblies will selectively interconnect one of the two input shafts to the engine. Control of the dual clutch assembly is normally via an automatic, or at least semi-automatic, control system, in which actuation of the multi-plate clutch assemblies is mechanical, electro-mechanical, or hydraulic. In normal operation, a shift is accomplished by first engaging a desired gear pairing and by subsequently engaging the corresponding multi-plate clutch assembly.

Dual clutch transmissions have provided a number of improvements over conventional manual and automatic transmissions. For example, use of a multi-plate clutch assembly avoids inefficiencies associated with torque converters commonly found in automatic transmission assemblies. In addition to being lighter than a comparable automatic transmission, the dual clutch transmission can offer improved overall fuel consumption and quicker shift periods than a comparable manual transmission. Despite these improvements, the dual clutch transmissions normally require a cooling system to overcome heat build-up within the multi-plate clutch assemblies, particularly during shifting operation. To meet this need, prior art systems provided a dedicated pump to provide a bath of transmission fluid to the multi-plate clutch assembly. At least some prior art systems used a pump driven mechanically at flywheel speed. Separate from the cooling system, hydraulically-driven dual clutch transmissions require a pressurized fluid to actuate the multi-plate clutch assemblies. Thus, it was not uncommon in the prior art to include duplicate, non-cooperative systems adding weight and complexity to the design of dual clutch transmissions. Accordingly, there remains a need for an improved hydraulic control system suitable for a dual clutch transmission.

### SUMMARY OF THE INVENTION

Control systems and methods for a dual clutch transmission are provided. The control system generally includes a first pump for providing a first fluid to actuate the dual clutch transmission, a second pump for providing a second fluid to cool the dual clutch transmission, and a motor coupled to the first and second pumps. The motor is operable in first and second directions, where the first pump is responsive to operation of the motor in the first direction and the second pump is responsive to operation of the motor in the second direction. By selectively reversing motor rotation, the motor drives the first and second pumps to provide a flow rate of the first fluid and to provide a flow rate of the second fluid, respectively.

In one embodiment, the first pump provides a flow rate of hydraulic fluid to an accumulator. The accumulator maintains hydraulic pressure during periods where the first pump is unloaded or stopped. A shift valve and hydraulic actuator pairing can be disposed between the accumulator and a multi-disk clutch assembly contained within the dual clutch transmission. The shift valve can include a directional control valve with three ports and two distinct positions controlled by pressure in both directions using a pilot valve with a single solenoid and spring return.

In another embodiment, the accumulator provides a flow rate of hydraulic fluid to one or more hydraulic actuators to control selection of a desired gear pairing. The hydraulic actuators can be linear or x-y actuators influenced by a control valve, the control valve being controlled by pressure in two directions using a pilot valve with a single solenoid and spring return. Alternatively, the hydraulic actuators can include one or more rotary actuators having sequential shift barrels and an associated rotating cam.

In another embodiment, the second pump provides a flow rate of lubricating fluid to the multi-disk clutch assembly. The second pump draws lubricating fluid from a supply reservoir, and a heat exchanger is operable to maintain the temperature of the lubricating fluid at a level sufficient to cool the multi-disk clutch assembly. A flow restrictor and filter can be connected in parallel with the heat exchanger to permit an auxiliary flow of the transmission fluid to the multi-disk clutch assembly.

In another embodiment, a method is provided for controlling a dual clutch transmission. The method generally includes providing a motor operable in the first and second directions, operating the motor in the first direction to provide a hydraulic flow for actuating the dual clutch transmission, and operating the motor in the second direction to provide a lubricating flow for cooling the dual clutch transmission. The method can include providing a first pump drivable by the motor in only the first direction and providing a second pump drivable by the motor in only the second direction.

In still another embodiment, the method includes providing a first flow rate of a first fluid and providing a second flow rate of a second fluid. The first and second fluids can be the same fluid contained within a common supply reservoir. In other embodiments, the first and second fluids can be different fluids contained within separate supply reservoirs. At least a portion of the hydraulic flow is stored in a pressure accumulator in fluid communication with the first pump, and at least a portion of the lubricating flow is directed across a heat exchanger in fluid communication with the second pump.

In the above embodiments, the provision of a single motor to provide power to both pumps provides both weight and energy savings. In addition, a single motor can minimize the overall size of the transmission and provide improvements in the assembly of the same. These and other features and advantages of the present invention will become apparent from the following description of the invention, when viewed in accordance with the accompanying drawings and appended claims.

### BRIEF DESCRIPTION OF THE DRAWING

FIG. 1 is a schematic representation of a control system in accordance with an embodiment of the present invention.

FIG. 2 is a flow chart illustrating a method for operating the control system of FIG. 1.

### DETAILED DESCRIPTION OF THE CURRENT EMBODIMENTS

The current embodiments provide an improved control system and method for a dual clutch assembly. The control system generally includes a first pump for providing a hydraulic fluid to actuate the dual clutch assembly, a second pump for providing a lubricating fluid to cool the dual clutch assembly, and a motor operatively coupled to the first and second pumps. The motor is generally operable in a first direction to drive the first pump, and the motor is generally operable in a second direction to drive the second pump. By selectively reversing motor rotation, the motor drives the first and second pumps to provide a flow rate of hydraulic fluid and to provide a flow rate of lubricating fluid, respectively.

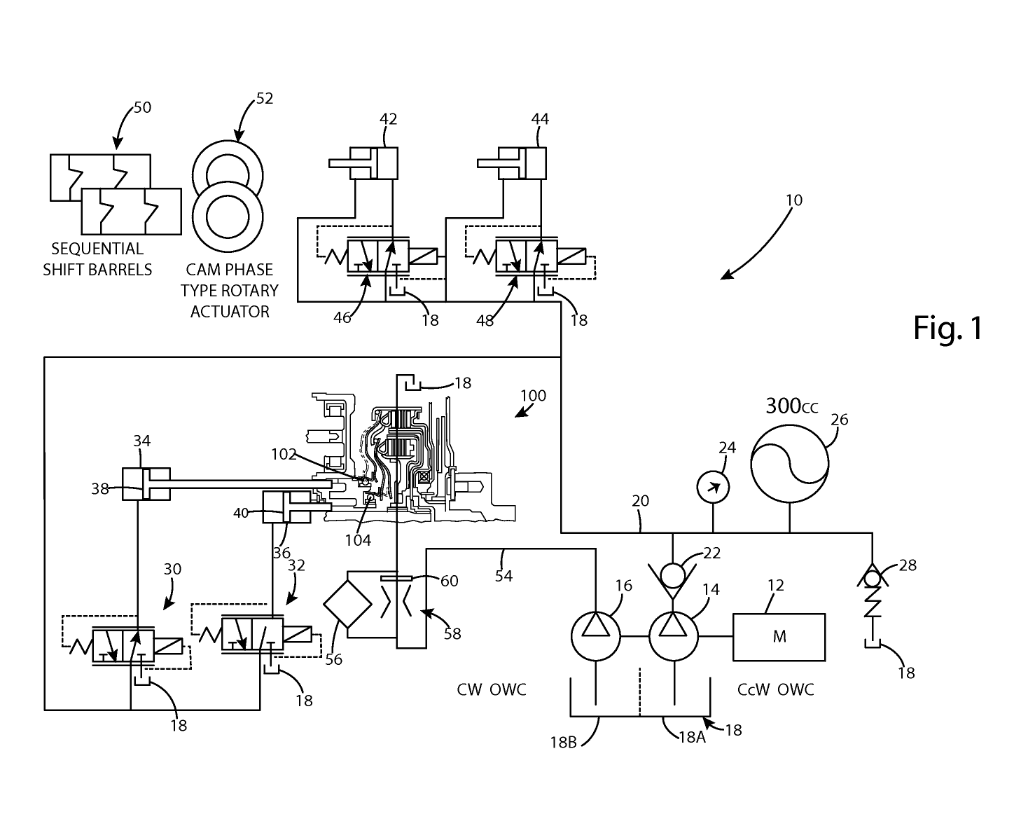

More particularly, and with reference to FIG. 1, a control system 10 for a dual clutch transmission 100 in accordance with an embodiment of the present invention is shown. The control system 10 includes a motor 12 to drive a first pump 14 and a second pump 16. The motor 12 is operable in two directions to drive either of the first pump 14 or the second pump 16. In one embodiment, the first and second pumps 14, 16 are mounted about a common transfer shaft driven by the motor 12. In another embodiment, the first and second pumps 14, 16 are belt driven by the motor 12. Optionally, the first and second pumps 14, 16 are functional in only a single direction, such that operation in any other direction will render the pump as non-functioning despite power being applied by the motor. For example, in a first or a counter-clockwise direction the motor 12 provides power to only the first pump 14, while in a second or clockwise direction the motor 12 provides power to only the second pump 16. In this regard, a single motor 12 selectively drives first and second pumps 14, 16 simply by reversing the motor rotation.

As also shown in FIG. 1, the first pump 14 draws a first fluid from a fluid reservoir 18 to load a hydraulic fluid supply line 20 across a one-way check valve 22. The hydraulic fluid supply line 20 includes a pressure sensor 24, a hydraulic accumulator 26, and a pressure release valve 28. The hydraulic accumulator 26 can maintain line pressure in the hydraulic fluid supply line 20 when the first pump 14 is unloaded or stopped, or in case of power failure. In the illustrated embodiment, a 300 cc accumulator is shown, however the specific capacity of the accumulator 26 can be selected to best accommodate system demands. For example, the hydraulic accumulator 26 can be selected to adequately respond to temporary losses in fluid and therefore pressure in the hydraulic line 20. In one embodiment, the hydraulic accumulator 26 can maintain the desired pressure in the hydraulic fluid supply line 20 despite losses due to shifting, often in the range of 10 to 15 cc's of hydraulic fluid per shift, and losses due to slight leaks through the shift valves, often as much as 4 to 8 cc's of hydraulic fluid per minute. As the fluid within the hydraulic accumulator 26 falls below acceptable levels, the first pump 14 can provide sufficient hydraulic fluid through the check valve 22 to the hydraulic accumulator 26. In this regard, the first pump 14 is not cycled on and off constantly, and instead operates to maintain pressure in the hydraulic line 20 through the periodic reloading of the accumulator 26.

As noted above, the hydraulic fluid supply line 20 provides a flow of hydraulic fluid to actuate the dual clutch assembly 100. The dual clutch assembly 100 can in turn include a first clutch assembly 102 and a second clutch assembly 104. The first and second clutches 102, 104 are assigned to separate transmissions paths to transfer torque from a prime mover to a final drive shaft. To actuate the first and second clutches 102, 104, first and second shift valves 30, 32 are provided between the accumulator 26 and first and second hydraulic actuators 34, 36, respectively. Each shift valve 30, 32 can include a proportional pressure control valve with three ports and two distinct positions controlled by pressure in both directions using a pilot valve with a single solenoid and spring return. For example, as the shift valves 30, 32 receive hydraulic fluid under pressure from the hydraulic fluid supply line 20, the corresponding work ports routes hydraulic fluid under pressure to or from the cap end 38, 40 of the hydraulic actuator 34, 36, thereby controlling the first and second clutch assemblies 102, 104. The actuation of each valve 30, 32 can generally result in a return of between 10 and 15 cc's of hydraulic fluid to the fluid reservoir 18 through a return line per shift. As the fluid within the hydraulic accumulator 26 falls below acceptable levels, the first pump 14 recharges the hydraulic fluid supply line 20. In addition to providing a source of hydraulic fluid to the first and second hydraulic actuators 34, 36, the hydraulic fluid supply line 20 can also provide pressured fluid to one or more hydraulic actuators 42, 44 to control selection of a desired gear pairing. For example, the hydraulic fluid supply line 20 can provide pressured fluid to the first and second linear shift actuators 42, 44 through corresponding directional control valves 46, 48. The control valves 46, 48 can be controlled by pressure in both directions using a pilot valve with a single solenoid and spring return. Optionally, the hydraulic actuators 42, 44 can include rotary actuators using, for example, sequential shift barrels 50 and a corresponding cam 52. While linear and rotary hydraulic actuators are shown, essentially any hydraulic actuator can be utilized.

As noted above, the control system 10 includes a second pump 16 to provide a fluid to cool and/or lubricate the dual clutch assembly 100, particularly during periods of frequent shifting. The second pump 16 can be a hydrostatic pump or a positive displacement pump, for example, and generally provides a fluid to the dual clutch assembly 100 at a lower pressure when compared to the pressure in the hydraulic fluid supply line 20. In one embodiment, the lubricating fluid can be the same fluid in the hydraulic fluid supply line 20. A common fluid can include a commercially available hydraulic fluid such as CHF11S from Pentosin-Werke Gmbh. In another embodiment the lubricating fluid can be separate from the hydraulic fluid in the hydraulic fluid supply line 20. In such a split system, for example, the reservoir 18 can include portioned or separated altogether. For example, the supply reservoir 18A can include a commercially available automatic transmission fluid such as DEXRON-III or DEXRON-VI by General Motors Corporation, and the supply reservoir 18B can include a commercially available gear lube or a synchromesh fluid such as 5W-30 by Amsoil, Inc. Generally, the additives, viscosity and other fluid properties of the hydraulic fluid and the lubricant fluid can each be tailored according to the desired system needs.

Referring again to FIG. 1, the second pump 16 provides a flow of lubricating fluid from the supply reservoir 18 to a lubricating supply line 54. The lubricating supply line 54 in turn provides a flow of lubricating fluid to the dual clutch assembly 100. The desired flow rate can be selected based on pump speed. As optionally shown in FIG. 1, the lubricating supply line can include a heat exchanger 56 in parallel with a flow restrictor 58 and filter 60. The heat exchanger 56 is operable to maintain the temperature of the lubricating fluid at a level sufficient to cool the dual clutch assembly 100. The flow restrictor 58 can include an suitable configuration, including a one bar check valve 58. The filter 60 is operable to remove metal filings and unwanted debris from the lubricating fluid. While only a small volume of lubricating fluid is diverted through the filter 60, over time the entire (or nearly so) volume of lubricating fluid is diverted through the filter 60. The lubricating fluid is therefore continuously filtered without unduly restricting the flow of lubricating fluid to the clutch assembly 100. In addition, the flow restrictor 58 can vary to allow a high flow rate of lubricating fluid as the fluid decreases in temperature and becomes more viscous, for example. In situations where very little lubricating fluid flows through the heat exchanger 56, the flow restrictor 58 enables flow of the lubricating fluid to the dual clutch assembly 100. As the volume of lubricating fluid accumulates within the dual clutch assembly 100 housing, centrifugal acceleration ejects the lubricating fluid from the clutch, and a separate flow path returns lubricating fluid to the supply reservoir 18.

While in some embodiments the flow rate of lubricating fluid will be greater than the flow rate of hydraulic fluid, in other embodiments the flow rate of lubricating fluid will be less than the flow rate of hydraulic fluid. In addition, the remainder of the transmission can be splashed cooled, optionally using a system of baffles or channels to direct the flow of fluid to the desired areas of the transmission.

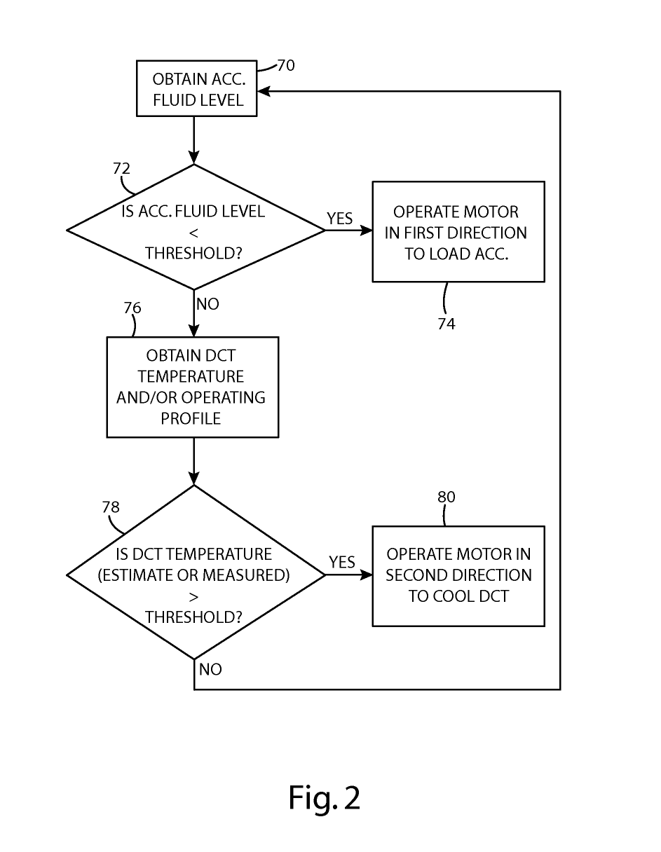

A method for operating of the control system 10 of FIG. 1 can be understood with reference to the flow diagram of FIG. 2. The method can generally include obtaining accumulator levels at step 70 to determine if the pressure in the hydraulic fluid supply line is below acceptable levels. Optionally, the accumulator volume is continuously measured by a Transmission Control Unit at step 70. In other embodiments, however, the accumulator volume is periodically measured by a Transmission Control Unit. At step 72, the Transmission Control Unit can determine if the accumulator fluid level is within acceptable levels. If at step 72 the accumulator fluid level is below acceptable levels, the motor 12 can operate in the first direction. As noted above, the motor 12 can drive the first pump 14 to thereby provide positive pressure to hydraulic line 20 and to load the accumulator 26. The second pump 16 can remain engaged with the motor 12 but is generally disabled or nonoperable when the motor 12 operates in the first direction. If at step 72 the accumulator fluid level is within acceptable levels, the Transmission Control Unit can obtain the temperature of the dual clutch assembly 100 at step 76. The temperature of the dual clutch assembly 100 can be directly, indirectly, or inferentially determined by the Transmission Control Unit according to any suitable method. For example, the temperature of the dual clutch assembly 100 can be estimated based on the number of actuations of the first and second clutches 102, 104 within a given period of time, and adjusted based on variations in engine temperature, ambient temperature, lubricating fluid temperature, or one or more other values. At step 78, the Transmission Control Unit can determine if the temperature of the dual clutch transmission 100 is operating within acceptable levels. If at step 78 the actual or estimated temperature of the dual clutch transmission 100 is above acceptable levels, the motor 12 can operate in the second direction. The motor 12 can drive the second pump 16 to thereby provide positive pressure to lubricating line 54 and to provide a bath of lubricating fluid to the dual clutch assembly 100. The first pump 14 can remain engaged with the motor 12 but is generally disabled or nonoperable when the motor 12 operates in the second direction. If at step 78 the actual or estimated temperature of the dual clutch assembly 100 is within acceptable levels, the Transmission Control Unit can repeat the above process beginning again at step 70.

While described above in combination with a dual clutch transmission, the control system 10 can be adapted for use with essentially any transmission. For example, the control system 10 can be used in conjunction with a wide variety of manual, automatic, semi-automatic transmissions. To reiterate, a motor 12 operates in a first direction to drive a first pump 14 while a second pump 16 is disabled or optionally decoupled from the motor 12. The motor 12 operates in a second direction to drive the second pump 16 while the first pump 14 is disabled or optionally decoupled from the motor 12. In this regard, a single motor 12 drives first and second pumps 14, 16 by reversing the motor rotation to provide a flow rate of hydraulic fluid and to provide a flow rate of lubricating fluid, respectively.

The above description is that of current embodiments of the invention. Various alterations and changes can be made without departing from the spirit and broader aspects of the invention as defined in the appended claims, which are to be interpreted in accordance with the principles of patent law including the doctrine of equivalents. Any reference to elements in the singular, for example, using the articles “a,” “an,” “the,” or “said,” is not to be construed as limiting the element to the singular.

1. A control system for a dual clutch assembly, comprising:
a first pump for providing a first fluid to actuate the dual clutch assembly;
a second pump for providing a second fluid to cool the dual clutch assembly; and
a motor coupled to the first and second pumps and operable in first and second directions, the first pump being responsive to operation of the motor in the first direction to provide sufficient hydraulic pressure to actuate the dual clutch assembly, the second pump being responsive to operation of the motor in the second direction to provide a sufficient flow rate of the second fluid to cool the dual clutch assembly.

2. The control system of claim 1 further comprising a pressure accumulator in fluid communication with the first pump.

3. The control system of claim 1 further comprising a heat exchanger in fluid communication with the second pump.

4. The control system of claim 3 further comprising a filter and a flow restrictor connected in parallel with the heat exchanger.

5. The control system of claim 1 further comprising a fluid reservoir including the first and second fluids.

6. The control system of claim 1 further comprising a first fluid reservoir including the first fluid and a second fluid reservoir including the second fluid.

7. The control system of claim 5 wherein the first and second fluids comprise a single fluid for both hydraulic actuation and cooling.

8. The control system of claim 6 wherein the first fluid is different from the second fluid.

9. The control system of claim 1 further comprising a transfer shaft driven by the motor, wherein the first and second pumps are mounted about the transfer shaft.

10. A method for controlling a dual clutch assembly, comprising:
providing a motor operable in first and second directions;
operating the motor in the first direction to provide a hydraulic flow for actuating the dual clutch assembly; and
operating the motor in the second direction to provide a lubricating flow for cooling the dual clutch assembly.

11. The method of claim 10 further including:
providing a first pump drivable by the motor in only the first direction; and
providing a second pump drivable by the motor in only the second direction.

12. The method of claim 11 wherein the first pump provides a flow rate of a first fluid and the second pump provides a flow rate of a second fluid different from the first fluid.

13. The method of claim 11 wherein the first and second pumps provide first and second flow rates, respectively, of a common fluid.

14. The method of claim 11 further including a transfer shaft driven by the motor, wherein the first and second pumps are mounted about the transfer shaft.

15. The method of claim 11 wherein at least a portion of the hydraulic flow is stored in a pressure accumulator in fluid communication with the first pump.

16. The method of claim 11 wherein at least a portion of the lubricating flow is directed across a heat exchanger in fluid communication with the second pump.

17. A control system comprising:
a transmission including a multi-disk clutch assembly and first and second hydraulic actuators;
a first pump for supplying a first fluid to a first output line, the first output line directing the flow of the first fluid to the first and second hydraulic actuators;
a second pump for supplying a second fluid to a second output line, the second output line directing the flow of the second fluid to the multi-disk clutch assembly; and
a motor coupled to the first and second pumps and operable in first and second directions, the first pump being responsive to operation of the motor in the first direction to pressurize the first fluid in the first output line and the second pump being responsive to operation of the motor in the second direction to pressurize the second fluid in the second output line.

18. The control system of claim 17 wherein the transmission is a dual clutch transmission.

19. The control system of claim 17 further comprising a pressure accumulator in fluid communication with the first pump.

20. The control system of claim 17 further comprising third and fourth hydraulic actuators to control selection of a desired torque path, the third and fourth hydraulic actuators being in fluid communication with the first output line.

21. The control system of claim 17 further comprising a heat exchanger in fluid communication with the second pump.

22. The control system of claim 21 further comprising a filter and a flow restrictor in parallel with the heat exchanger.

23. The control system of claim 17 further comprising a fluid reservoir including the first and second fluids.

24. The control system of claim 17 further comprising a first fluid reservoir including the first fluid and a second fluid reservoir including the second fluid.

25. The control system of claim 23 wherein the first and second fluids comprise a single fluid for both hydraulic actuation and cooling.

26. The control system of claim 24 wherein the first fluid is different from the second fluid.

27. The control system of claim 17 further comprising a one way check valve disposed between the first pump and the first output line.
